(19) United States
(12) Patent Application Publication
(10) Pub. No.: US 2015/0027863 A1
(43) Pub. Date: Jan. 29, 2015

(54) ELECTRIC ARC ELIMINATING APPARATUS

(71) Applicants: Hon Hai Precision Industry Co., Ltd., New Taipei (TW); Hong Fu Jin Precision Industry (Shenzhen) Co., Ltd, Shenzhen (CN)

(72) Inventor: WEI-HUA CAO, Shenzhen (CN)

(73) Assignees: HONG FU JIN PRECISION INDUSTRY (ShenZhen) CO., LTD, Shenzhen (CN); HON HAI PRECISION INDUSTRY CO., LTD., New Taipei (TW)

(21) Appl. No.: 14/226,534

(22) Filed: Mar. 26, 2014

(30) Foreign Application Priority Data
Jul. 26, 2013 (CN) 2013103186277

(51) Int. Cl. H01R 31/08

(52) U.S. Cl. CPC H01R 31/08
USPC 200/51.09

(57) ABSTRACT

An electric arc eliminating apparatus includes a switch member, an interface, a power supply circuit and a connector. The switch member includes a contacting unit and a triggering unit. The power supply circuit is electrically coupled to the interface via the contacting unit. When the connector is inserted into the interface but does not completely connect with the interface, the contacting unit is in an open state, and the power supply circuit cannot output electrical power to the connector via the interface. When the connector is inserted into the interface and completely connected with the interface, the connector resists against the triggering unit and moves the triggering unit toward the contacting unit, the contacting unit is in a closed state, and the power supply circuit provides electrical power to the connector via the interface.

### FIELD

The present disclosure relates to an electric arc eliminating apparatus.

### BACKGROUND

Electronic devices have a number of interfaces such as USB interfaces and audio interfaces. Peripheral devices need to be inserted into interfaces of the electronic devices to transmit data. An electric arc is generated when inserting the connector into an interface. The electric arc may be stronger when an electric potential between the connector and the interface is greater than 10 volts, which is dangerous to people.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of an electric arc eliminating apparatus, the electric arc eliminating apparatus including a power supply circuit, a switch member and an interface.

FIG. 2 is a block diagram of the electric arc eliminating apparatus of FIG. 1, further including a connector, a discharging circuit and an electronic device.

FIG. 3 is a circuit diagram of the electric arc eliminating apparatus of FIGS. 1 and 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In the following description the term “coupled” is defined as connected, whether directly or indirectly through intervening components, and is not necessarily limited to physical connections. The connection can be such that the objects are permanently connected or releasably connected.

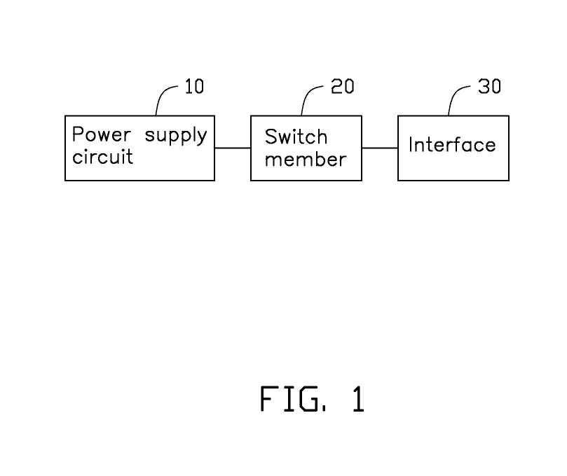

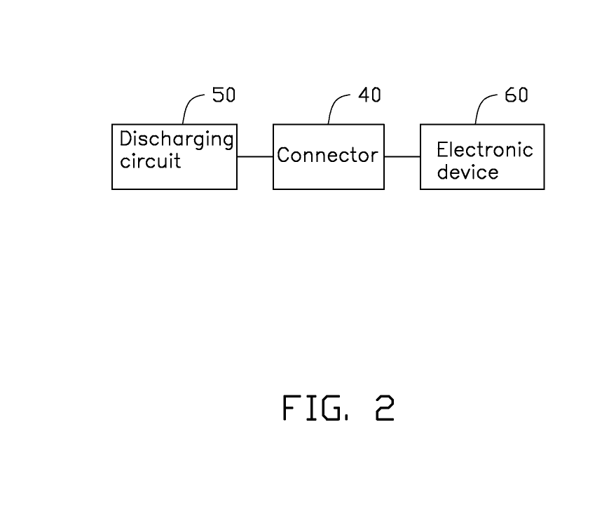

FIGS. 1 and 2 show an electric arc eliminating apparatus of an illustrative embodiment. The electric arc eliminating apparatus includes a power supply circuit 10, a switch member 20, an interface 30, a connector 40, a discharging circuit 50 and an electronic device 60.

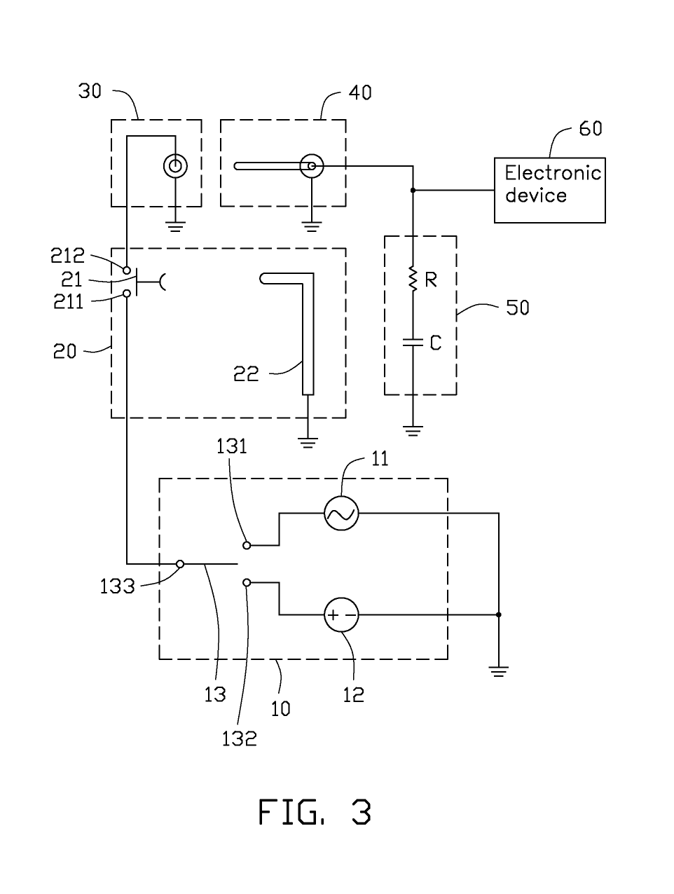

FIG. 3 shows the power supply circuit 10 including an AC power source 11, a DC power source 12 and a single-pole double-throw (SPDT) switch 13. The SPDT switch 13 includes a first terminal 131, a second terminal 132, and a third terminal 133. The first terminal 131 of the SPDT switch 13 is electrically coupled to the AC power source 11. The second terminal 132 of the SPDT switch 13 is electrically coupled to the DC power source 12.

The switch member 20 includes a contacting unit 21 and a triggering unit 22. The contacting unit 21 includes a first terminal 211 and a second terminal 212. The first terminal 211 of the contacting unit 21 is electrically coupled to the third terminal 133 of the SPDT switch 13. The second terminal 212 of the contacting unit 21 is grounded via the interface 30.

In one embodiment shown in FIG. 3, the contacting unit 21 is a mechanical switch point contact. The contacting unit 21 and the triggering unit 22 are located within the interface 30 and in a rear side of the interface 30. When the connector 40 is inserted into the interface 30 and completely connected with the interface 30, the connector 40 resists against the triggering unit 22 and moves the triggering unit 22 toward the contacting unit 21. The contacting unit 21 is closed and electrically couples the power supply circuit 10 with the interface 30 and the connector 40.

The discharging circuit 50 includes a resistor 51 and a capacitor 52. A first terminal of the resistor 51 is grounded via the connector 40. The first terminal of the resistor 51 is electrically coupled to the electronic device 60. A second terminal of the resistor 51 is grounded via the capacitor 52.

In use, the SPDT switch 13 is actuated to select the corresponding power source providing electrical power to the electronic device 60. When the SPDT switch is moved to a first position, the first terminal 131 and the third terminal 133 of the SPDT switch 13 are electrically coupled, the AC power source 11 provides electrical power to the electronic device 60. When the SPDT switch is moved to a second position, the second terminal 132 and the third terminal 133 of the SPDT switch 13 are electrically coupled, the DC power source 12 provides electrical power to the electronic device 60.

When the connector 40 is partially inserted into the interface 30 (i.e. does not completely connect with the interface 30), the contacting unit 21 is in an open state. The power supply circuit 10 cannot output electrical power to the connector 40 and the electronic device 60 via the interface 30. Thus, an electric potential is not generated when the connector 40 is partially inserted into the interface 30. Therefore, an electric arc is not generated.

When the connector 40 is fully inserted into the interface 30 (i.e. completely connected with the interface 30), the contacting unit 21 is in a closed state. The power supply circuit 10 provides electrical power to the connector 40 and the electronic device 60 via the interface 30. Thus, as the power supply circuit 10 only provides electrical power to the electronic device 60 when the connector 40 is completely connected with the interface 30, the electric arc generated by the electric potential is avoided.

Furthermore, when the connector 40 is moved out of (or withdrawn from) the interface 30, the connector 40 releases the triggering unit 22. The triggering unit 22 moves away from the contacting unit 21. The contacting unit 21 is opened again. A resting current in the connector 40 and the electronic device 60 is grounded via the resistor 51 and the capacitor 52 in sequence. Therefore, the electric arc is further avoided when the connector 40 is moved out of the interface 30.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. An electric arc eliminating apparatus, comprising:
a switch member having a contacting unit and a triggering unit;
an interface;
a power supply circuit electrically coupled to the interface via the contacting unit; and
a connector; wherein when the connector is partially inserted into the interface so as not to completely connect with the interface, the contacting unit is in an open state, and the power supply circuit cannot output electrical power to the connector via the interface; and when the connector is fully inserted into the interface so as to completely connect with the interface, the connector resists against the triggering unit moving the triggering unit toward the contacting unit and into a closed state allowing the power supply circuit to provide electrical power to the connector via the interface.

2. The electric arc eliminating apparatus of claim 1, wherein the power supply circuit comprises an AC power source; a DC power source; and a single-pole double-throw (SPDT) switch having a first terminal and a second terminal; further wherein the first terminal of the SPDT switch is electrically coupled to the AC power source; and the second terminal of the SPDT switch is electrically coupled to the DC power source.

3. The electric arc eliminating apparatus of claim 2, wherein the SPDT switch further comprises a third terminal; and further wherein when the first terminal of the SPDT switch is electrically coupled to the third terminal of the SPDT switch, the AC power source provides electrical power to the connector; and when the second terminal of the SPDT switch is electrically coupled to the third terminal of the SPDT switch, the DC power source provides electrical power to the connector.

4. The electric arc eliminating apparatus of claim 2, wherein the contacting unit comprises a first terminal and a second terminal; wherein the first terminal of the contacting unit is electrically coupled to the third terminal of the SPDT switch; and the second terminal of the contacting unit is grounded via the interface.

5. The electric arc eliminating apparatus of claim 4, wherein the contacting unit is a mechanical switch of point contact; and the contacting unit and the triggering unit are located within the interface.

6. The electric arc eliminating apparatus of claim 1, further comprising an electronic device and a discharging circuit; wherein the electronic device is electrically coupled to the connector; the electronic device is grounded via the discharging circuit; and when the connector is withdrawn from the interface, the connector and the electronic device discharge via the discharging circuit.

7. The electric arc eliminating apparatus of claim 6, wherein when withdrawing the connector from the interface, the connector releases the triggering unit, the triggering unit moves away from the contacting unit, the contacting unit is opened, and the power supply circuit cannot output electrical power to the connector and the electronic device via the interface.

8. The electric arc eliminating apparatus of claim 6, wherein the discharging circuit comprises a resistor and a capacitor; a first terminal of the resistor is grounded via the connector; the first terminal of the resistor is electrically coupled to the electronic device; and a second terminal of the resistor is grounded via the capacitor.

9. An electric arc eliminating apparatus, comprising:
a switch member having a contacting unit and a triggering unit;
an interface;
a power supply circuit electrically coupled to the interface via the contacting unit;
a discharging circuit; and
a connector grounded via the discharging circuit; wherein when the connector is partially inserted into the interface so as not to completely connect with the interface, the contacting unit is in an open state, and the power supply circuit cannot output electrical power to the connector via the interface and when the connector is fully inserted into the interface so as to completely connect with the interface, the connector resists against the triggering unit moving the triggering unit toward the contacting unit and into a closed state, allowing the power supply circuit to provide electrical power to the connector via the interface; and when the connector is moved out of the interface, the connector discharges via the discharging circuit.

10. The electric arc eliminating apparatus of claim 9, wherein the power supply circuit comprises an AC power source; a DC power source; and a single-pole double-throw (SPDT) switch having a first terminal and a second terminal; further wherein the first terminal of the SPDT switch is electrically coupled to the AC power source; and the second terminal of the SPDT switch is electrically coupled to the DC power source.

11. The electric arc eliminating apparatus of claim 10, wherein the SPDT switch further comprises a third terminal; and further wherein when the first terminal of the SPDT switch is electrically coupled to the third terminal of the SPDT switch, the AC power source provides electrical power to the connector; and when the second terminal of the SPDT switch is electrically coupled to the third terminal of the SPDT switch, the DC power source provides electrical power to the connector.

12. The electric arc eliminating apparatus of claim 10, wherein the contacting unit comprises a first terminal and a second terminal; wherein the first terminal of the contacting unit is electrically coupled to the third terminal of the SPDT switch; and the second terminal of the contacting unit is grounded via the interface.

13. The electric arc eliminating apparatus of claim 12, wherein the contacting unit is a mechanical switch of point contact; and the contacting unit and the triggering unit are located within the interface.

14. The electric arc eliminating apparatus of claim 9, further comprising an electronic device; wherein the electronic device is electrically coupled to the connector; the electronic device is grounded via the discharging circuit; and when the connector is withdrawn from the interface, the electronic device discharges via the discharging circuit.

15. The electric arc eliminating apparatus of claim 14, wherein when withdrawing the connector from the interface, the connector releases the triggering unit, the triggering unit moves away from the contacting unit, the contacting unit is opened, and the power supply circuit cannot output electrical power to the connector and the electronic device via the interface.

16. The electric arc eliminating apparatus of claim 14, wherein the discharging circuit comprises a resistor and a capacitor; a first terminal of the resistor is grounded via the connector; the first terminal of the resistor is electrically coupled to the electronic device; and a second terminal of the resistor is grounded via the capacitor.
